(19) United States
(12) Patent Application Publication
(10) Pub. No.: US 2024/0356183 A1
(43) Pub. Date: Oct. 24, 2024

(54) PROTECTIVE ELEMENT AND BATTERY PACK

(71) Applicant: DEXERIALS CORPORATION, Shimotsuke-shi, Tochigi (JP)

(72) Inventor: Yu NOMURA, Shimotsuke-shi, Tochigi (JP)

(73) Assignee: DEXERIALS CORPORATION, Shimotsuke-shi, Tochigi (JP)

(21) Appl. No.: 18/688,385

(22) PCT Filed: Sep. 8, 2022
(86) PCT No.: PCT/JP2022/033686

§ 371 Date: Mar. 1, 2024

(30) Foreign Application Priority Data
Sep. 10, 2021 (JP) 2021-148187

(51) Int. Cl. H01M 50/583; H01H 85/00; H01H 85/055; H01M 10/42; H01M 10/615; H01M 10/653; H01M 10/6571

(52) U.S. Cl. CPC H01M 50/583; H01H 85/0047; H01H 85/055; H01M 10/425; H01M 10/615; H01M 10/653; H01M 10/6571; H01M 2200/103

(57) ABSTRACT

A protective element includes: an insulating substrate; first and second electrodes provided on the insulating substrate; a heating element formed on the insulating substrate; a heating-element extraction electrode electrically connected to the heating element; a fusible conductor mounted from the first electrode to the second electrode with the heating-element extraction electrode interposed between the first and second electrodes; and an insulating protective layer which covers the heating element and includes a thermally conductive filler.

### TECHNICAL FIELD

The present art relates to a protective element that cuts off a current path at the time of an abnormality such as an overcharge or an overdischarge and to a battery pack that uses this protective element. The present application claims priority to Japanese Patent Application No. 2021-148187 filed in Japan on Sep. 10, 2021, the contents of which are incorporated into the present application by reference.

### BACKGROUND TECHNOLOGY

Many secondary cells that can be charged and repeatedly used are provided to a user by being made into a battery pack. In particular, with lithium-ion secondary cells, which have a high specific energy, many built-in protective circuits for overcharge protection, overdischarge protection, and the like are generally provided in the battery pack, and a function is generally provided of cutting off the output of the battery pack in predetermined instances. These features are provided to ensure the safety of the user and the electronic device.

A structure in which a heating element is provided inside a protective element and heat generation by this heating element fuses a fusible conductor that is on a current path is used as a protective element of such protective circuits for a lithium-ion secondary cell or the like.

The scope of application of lithium-ion secondary cells is increasing in recent years, and higher-current applications—for example, adoption in devices such as power screwdrivers and other power tools, drones, electric motorcycles, hybrid vehicles, electric automobiles, and power-assisted bicycles—have started. This increase in the scope of application of lithium-ion secondary cells has also created the need for protective elements to meet various demands. Among these demands, characteristics relating to high responsiveness and high reliability are some of the most important indicators, given the nature of protective elements of ensuring safety.

FIG. 12 is a diagram showing one configuration example of a conventional protective element. (A) is a plan view that is shown by omitting a cover member, (B) is a sectional view, and (C) is a bottom view. The protective element 100 shown in FIG. 12 is provided with: an insulating substrate 101; first and second electrodes 102, 103 that are formed on the front surface of the insulating substrate 101; a heating element 104 that is formed on the front surface of the insulating substrate 101; an insulating layer 105 that covers the heating element 104; a heating-element extraction electrode 106 that is layered on the insulating layer 105 and is connected to the heating element 104; and a fuse element 107 that is a fusible conductor that is mounted by means of connecting solder across the first electrode 102, the heating-element extraction electrode 106, and the second electrode 103.

The first and second electrodes 102, 103 are terminal portions that are connected on a current path of an external circuit to which the protective element 100 is connected. The first electrode 102 is connected by means of castellations to a first external-connection electrode 102a that is formed on the rear surface of the insulating substrate 101, and the second electrode 103 is connected by means of castellations to a second external-connection electrode 103a that is formed on the rear surface of the insulating substrate 101. In the protective element 100, the fuse element 107 is incorporated into a portion of the current path, which is formed on an external circuit substrate, by the first and second external-connection electrodes 102a, 103a being connected to connection electrodes that are provided to the external circuit substrate, on which the protective element 100 is mounted.

The heating element 104 is an electrically conductive member that has a comparatively high resistance value and generates heat when energized and is made of, for example, nichrome, W, Mo, or Ru or a material containing such. The heating element 104 is connected to a heating-element electrode 108 that is formed on the front surface of the insulating substrate 101. The heating-element electrode 108 is connected by means of castellations to a third external-connection electrode 108a that is formed on the rear surface of the insulating substrate 101. In the protective element 100, the heating element 104 is connected to an external power source that is provided to the external circuit by the third external-connection electrode 108a being connected to a connection electrode that is provided to the external circuit substrate on which the protective element 100 is mounted. A switch element or the like that is not illustrated continuously controls energization and heat generation of the heating element 104.

The heating element 104 is covered by the insulating layer 105, which is made of a glass layer or the like, and overlaps the heating-element extraction electrode 106 with the insulating layer 105 being interposed therebetween by the heating-element extraction electrode 106 being formed on the insulating layer 105. The fuse element 107, which is connected from the first electrode 102 to the second electrode 103, is connected on the heating-element extraction electrode 106.

Thus, in the protective element 100, the heating element 104 and the fuse element 107 are thermally connected by overlapping, and the fuse element 107 can be fused when the heating element 104 generates heat by being energized.

The fuse element 107 is formed of lead-free solder or another low-melting-point metal or of Ag, Cu, an alloy having such as its main component, or another high-melting-point metal. Alternatively, the fuse element has a layered structure of a low-melting-point metal and a high-melting-point metal. The fuse element 107 constitutes a portion of the current path of the external circuit into which the protective element 100 is incorporated by being connected from the first electrode 102 to the second electrode 103 with the heating-element extraction electrode 106 being interposed between the electrodes. The fuse element 107 is fused by self-heating (Joule heating) due to being energized by a current that exceeds the rating of the fuse element. Alternatively, the fuse element is fused by heat generation by the heating element 104. The fusion cuts off the current path between the first and second electrodes 102, 103.

In the protective element 100, the switch element enables the heating element 104 to be energized when a need arises to cut off the current path of the external circuit. Thus, in the protective element 100, the heating element 104 generates high-temperature heat, and the fuse element 107 that is incorporated into the current path of the external circuit is melted. The fuse element 107 is fused by a melting conductor of the fuse element 107 being pulled toward the heating-element extraction electrode 106 and first and second electrodes 102, 103, which have high wettability. Therefore, the protective element 100 can cut off the current path of the external circuit by fusing the path that passes through the first electrode 102, the heating-element extraction electrode 106, and the second electrode 103.

### CITATION LIST

### Patent Documents

Patent Document 1: Japanese Unexamined Patent Application Publication No. 2015-35281

### SUMMARY OF INVENTION

### Problem to be Solved by Invention

The insulating layer 105 is formed by using, for example, thick-film printing technology. The thickness of the glass that can be formed by the printing process is generally 10 to 60 μm, which is very thin. Thus, the heat generated by the heating element 104 can be efficiently transferred to the fuse element 107.

However, secondary cells are increasingly being used in applications involving higher voltages, and use in which the voltage applied to the heating element 104 exceeds 42 V, which is a safe and low voltage, is becoming standard. The insulating layer 105 is formed to be very thin as described above and thus may be formed with pin holes or the like that arise in the glass layer at the time of printing. Thus, there are instances in which insulation breakdown occurs at the pin holes or other locations of decreased insulation performance when a high voltage is applied to the heating element 104 and the heating element 104 is destroyed before generating sufficient heat as shown in FIG. 13.

Increasing the number of times of printing to increase the thickness of the insulating layer 105 can be mentioned as a countermeasure. The insulating layer 105 is generally formed at a film thickness of 20 um or greater in order to prevent insulation breakdown when the heating element 104 is energized.

However, the efficiency by which heat is conducted to the fuse element 107 decreases as the film thickness of the insulating layer 105 increases, and rapid fusion cannot be performed when, for example, the thickness of the fuse element 107 is increased in order to realize a protective element that can handle a large current.

Thus, the purpose of the present art is to provide a protective element and a battery pack that can prevent a fuse element from fusing rapidly and undergoing insulation breakdown and can provide high responsiveness and high reliability.

### Means to Solve the Problem

To solve the problem above, a protective element of the present art is provided with: an insulating substrate; first and second electrodes that are provided on the insulating substrate; a heating element that is formed on the insulating substrate; a heating-element extraction electrode that is electrically connected to the heating element; a fusible conductor that is mounted from the first electrode to the second electrode with the heating-element extraction electrode interposed between these electrodes; and an insulating protective layer that covers the heating element; wherein the insulating protective layer contains a thermally conductive filler.

A battery pack of the present art is provided with: one or more battery cells; a protective element that is connected on a charge/discharge path of the battery cell and cuts off the charge/discharge path; and a current control element that detects the voltage value of the battery cell and controls energization of the protective element; wherein the protective element is provided with an insulating substrate, first and second electrodes that are provided on the insulating substrate, a heating element that is formed on the insulating substrate, a heating-element extraction electrode that is electrically connected to the heating element, a fusible conductor that is mounted from the first electrode to the second electrode with the heating-element extraction electrode interposed between these electrodes, and an insulating protective layer that covers the heating element, and the insulating protective layer contains a thermally conductive filler.

### Effect of the Invention

According to the present art, raising the thermal conductivity of the insulating layer increases the rate of thermal conduction from the heating element to the fusible conductor. Moreover, a protective element that can prevent insulation breakdown and provides high responsiveness and high reliability can be provided.

### BRIEF DESCRIPTION OF THE DRAWINGS

FIG. 1 is a diagram showing one configuration example of a protective element in which the present art is applied. (A) is a plan view that is shown by omitting a cover member, (B) is a sectional view, and (C) is a bottom view.

FIG. 2 is a diagram showing a state in which a fusible conductor is fused in the protective element shown in FIG. 1. (A) is a plan view that is shown by omitting the cover member, and (B) is a sectional view.

FIG. 3 is a conceptual diagram showing thermal conduction in an insulating protective layer.

FIG. 4 is a graph showing the correspondence between thermal conductivity and the volume fraction of aluminum oxide in an insulating protective layer in which aluminum oxide (thermal conductivity: 40 W/mK) is dispersed in glass (thermal conductivity: 1 W/mK).

FIG. 5 is a graph showing the correspondence between thermal conductivity and the volume fraction of aluminum nitride in an insulating protective layer in which aluminum nitride (thermal conductivity: 285 W/mK) is dispersed in glass (thermal conductivity: 1 W/mK).

FIG. 6 is a sectional view of the fusible conductor.

FIG. 7 is a circuit diagram showing a configuration example of a battery pack.

FIG. 8 is a circuit diagram of the protective element.

FIG. 9 is a sectional view showing a variation of the protective element in which the present art is applied.

FIG. 10 is a diagram showing one configuration example of a protective element in which the heating element is provided on the rear surface of the insulating substrate. (A) is a plan view that is shown by omitting the cover member, (B) is a sectional view, and (C) is a bottom view.

FIG. 11 is a diagram showing a state in which the fusible conductor is fused in the protective element shown in FIG. 10. (A) is a plan view that is shown by omitting the cover member, and (B) is a sectional view.

FIG. 12 is a diagram showing a conventional protective element. (A) is a plan view, (B) is a sectional view, and (C) is a bottom view.

FIG. 13 is a plan view showing a state in which a spark has arisen in the protective element shown in FIG. 12.

### DESCRIPTION OF THE EMBODIMENTS

A protective element and battery pack in which the present art is applied are described in detail below with reference to the drawings. The present art is not limited to the following embodiment and can as a matter of course be modified in various ways within a scope that does not depart from the gist of the present technology. The diagrams are schematic, and the dimensional proportions and the like may differ from the actual proportions and the like. The specific dimensions and the like should be determined by referring to the following description. It is also a matter of course that the diagrams include portions in which the dimensional relationships and proportions differ across different diagrams.

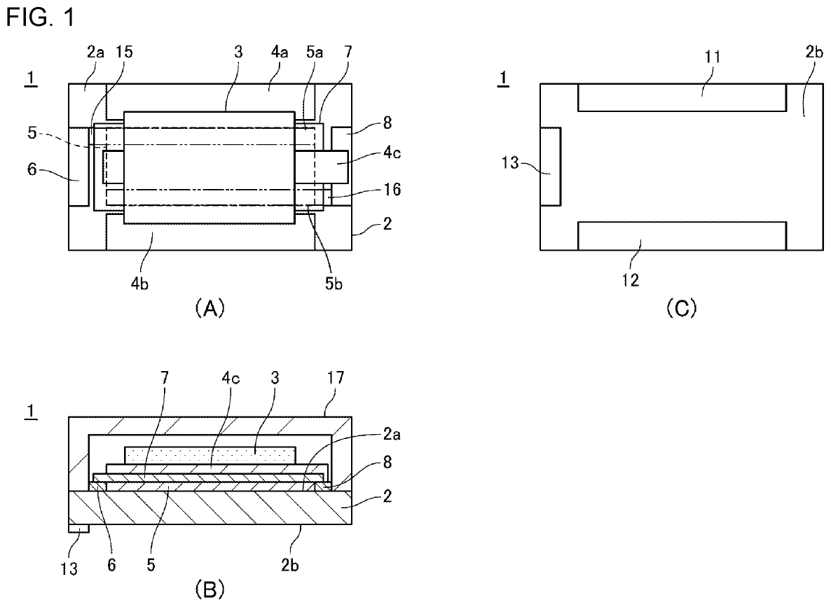

As shown in (A) to (C) in FIG. 1, a protective element 1 in which the present art is applied is provided with: an insulating substrate 2; a fusible conductor 3 that is supported on the insulating substrate 2; a first electrode 4a, second electrode 4b, and heating-element extraction electrode 4c that are connected to the fusible conductor 3; a heating element 5 that is provided on the insulating substrate 2 and generates heat by being energized; a heating-element electrode 6 that is connected to the heating element 5 and serves as a terminal that feeds power to the heating element 5; and an insulating protective layer 7 that covers the heating element 5.

In the protective element 1 shown in FIG. 1, the heating element 5 and the insulating protective layer 7 that covers the heating element 5 are formed on a front surface 2a on which the fusible conductor 3 is supported of the insulating substrate 2. The first electrode 4a, which is connected to one end portion of the fusible conductor 3, and the second electrode 4b, which is connected to the other end portion of the fusible conductor 3, are formed as energization units on the front surface 2a of the insulating substrate 2. The heating-element extraction electrode 4c, which is electrically connected to the heating element 5, overlaps the insulating protective layer 7 from above, and is also connected to the fusible conductor 3, is formed on the front-surface 2a side of the insulating substrate 2.

The insulating protective layer 7 is composed of an insulating material such as glass and contains a thermally conductive filler. Thus, the insulating protective layer 7 has improved thermal conduction efficiency and efficiently transmits the heat generated by the heating element 5 to the fusible conductor 3. Accordingly, there is no need to form the insulating protective layer 7 to be very thin in order to raise the thermal conduction efficiency, and insulation breakdown can be suppressed by forming the insulating protective layer to be thick enough to be able to prevent the generation of pin holes and the like. The fusible conductor 3 can be rapidly fused without forming the insulating protective layer 7 to be very thin. Thus, the heating element 5 becoming damaged prior to the fusible conductor 3 being fused can also be prevented.

Such a protective element 1 being incorporated into an external circuit causes the fusible conductor 3 to constitute a portion of a current path of the external circuit. The current path is cut off by being fused by the heat generated by the heating element 5 or an overcurrent that exceeds the rating of the current path. The configurations of the protective element 1 are described in detail below.

### Insulating Substrate

The insulating substrate 2 is formed by an insulating member such as alumina, a glass-ceramic, mullite, or zirconia. A material that is used in a glass epoxy board, a phenol board, or another printed circuit board may also be used for the insulating substrate 2.

### [First and Second Electrodes]

The first and second electrodes 4a, 4b are formed at two end portions that oppose each other of the insulating substrate 2. The first and second electrodes 4a, 4b are each formed by an electrically conductive pattern of Ag, Cu, or the like. A film of Ni/Au plating, Ni/Pd plating, Ni/Pd/Au plating, or the like is preferably coated by known means such as a plating process on the front surfaces of the first and second electrodes 4a, 4b. Such a film in the protective element 1 can prevent oxidation of the first and second electrodes 4a, 4b and rating fluctuations that accompany an increase in conduction resistance. Erosion (dissolution into solder) of the first and second electrodes 4a, 4b due to connecting solder that connects the fusible conductor 3 melting when reflow-mounting the protective element 1 can also be prevented.

The first electrode 4a is made to have continuity from the front surface 2a of the insulating substrate 2 to a first external-connection electrode 11 that is formed on the rear surface 2b by means of castellations. The second electrode 4b is made to have continuity from the front surface 2a of the insulating substrate 2 to a second external-connection electrode 12 that is formed on the rear surface 2b by means of castellations. The first and second external-connection electrodes 11, 12 are connected to connection electrodes, which are provided to the external circuit substrate, when the protective element 1 is mounted to the external circuit substrate, and this electrode connection incorporates the fusible conductor 3 into a portion of the current path that is formed on the external circuit substrate.

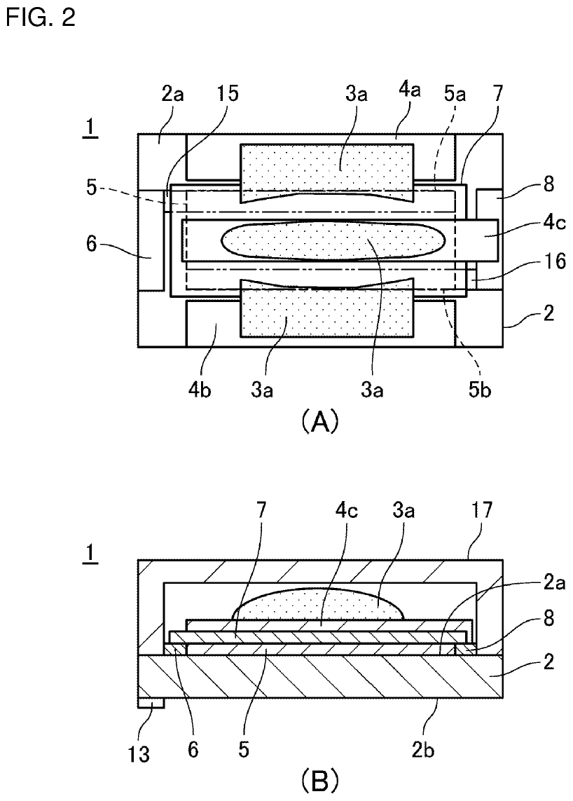

The first and second electrodes 4a, 4b are electrically connected by means of the fusible conductor 3 by the fusible conductor 3 being mounted by means of connecting solder or another electrically conductive connection material. As shown in (A) and (B) in FIG. 2, the connection between the first and second electrodes 4a, 4b is cut off by a large current that exceeds the rating of the protective element 1 flowing in the protective element such that the fusible conductor 3 is fused by self-heating (Joule heating). Alternatively, the connection is cut off by the heating element 5 being energized and generating heat so as to fuse the fusible conductor 3.

### [Heating Element]

The heating element 5 is an electrically conductive member that has a comparatively high resistance value and generates heat when energized and is made of, for example, nichrome, W, Mo, or Ru or a material containing such. The heating element 5 can be formed by, for example: mixing this alloy, composition, or compound in powder form with a resin binder or the like; using the resultant paste to form a pattern by means of screen-printing technology on the insulating substrate 2; and firing the printed pattern. As one example, the heating element 5 can be formed by: adjusting a mixed paste of a ruthenium oxide-based paste, silver, and a glass paste according to a predetermined voltage; forming a film of a predetermined area in a predetermined position on the front surface 2a of the insulating substrate 2; and afterward subjecting the mixed paste to a firing process under appropriate conditions. The shape of the heating element 5 can be designed as appropriate. However, making the heating element be substantially rectangular according to the shape of the insulating substrate 2 is preferable in terms of maximizing the heat-generation area, as illustrated in FIG. 1.

One end portion 5a of the heating element 5 is connected to a first extraction electrode 15, and another end portion 5b of the heating element is connected to a second extraction electrode 16. The first extraction electrode 15 is formed by being extracted from the heating-element electrode 6 along the one end portion 5a of the heating element 5. In the protective element 1 shown in FIG. 1, the first extraction electrode extends along and is overlapped by one lateral edge of the heating element 5 that is formed to be substantially rectangular. Likewise, the second extraction electrode 16 is formed by being extracted from an intermediate electrode 8 along the other end portion 5b of the heating element 5. In the protective element 1 shown in FIG. 1, the second extraction electrode extends along and is overlapped by another lateral edge of the heating element 5 that is formed to be substantially rectangular.

The heating-element electrode 6 and the intermediate electrode 8 are formed on mutually opposing lateral edges that are different from the lateral edges on which the first and second electrodes 4a, 4b are provided of the insulating substrate 2. The heating-element electrode 6 is an electrode that feeds power to the heating element 5, is connected to the one end portion 5a of the heating element 5 by means of the first extraction electrode 15, and has continuity with a third external-connection electrode 13 that is formed on the rear surface 2b of the insulating substrate 2 by means of castellations.

The heating-element electrode 6, the first and second extraction electrodes 15, 16, and the intermediate electrode 8 can be formed by printing and firing an electrically conductive paste of Ag, Cu, or the like as in the first and second electrodes 4a, 4b. Constituting these electrodes that are formed on the front surface 2a of the insulating substrate 2 from the same material enables the electrodes to be formed in one printing and firing process.

The heating-element electrode 6 may be provided with a regulating wall that prevents connecting solder from climbing up onto the heating-element electrode 6 by means of the castellations and wetting and spreading onto the heating-element electrode 6 upon the connecting solder, which is provided to the electrode of the external circuit substrate that is connected to the third external-connection electrode 13, melting during reflow mounting or the like. The first and second electrodes 4a, 4b may also be provided with a regulating wall. The regulating wall can be formed by using an insulating material that is not wettable by solder, such as glass, solder resist, or an insulating adhesive, and the regulating wall can be formed by printing or the like on the heating-element electrode 6. Providing the regulating wall can prevent melted connecting solder from wetting and spreading onto the heating-element electrode 6 and the first and second electrodes 4a, 4b and can maintain connectivity between the protective element 1 and the external circuit substrate.

The intermediate electrode 8 is an electrode that is provided between the heating element 5 and the heating-element extraction electrode 4c, which is layered on the insulating protective layer 7; is connected to the other end portion 5b of the heating element 5; and is connected to the heating-element extraction electrode 4c. The heating-element extraction electrode 4c overlaps the heating element 5 with the insulating protective layer 7 interposed therebetween and is connected to the fusible conductor 3.

### [Insulating Protective Layer]

The heating element 5, the first extraction electrode 15, and the second extraction electrode 16 are covered by the insulating protective layer 7. The heating-element extraction electrode 4c is formed on the insulating protective layer 7, and the fusible conductor 3 overlaps the insulating protective layer 7 from above.

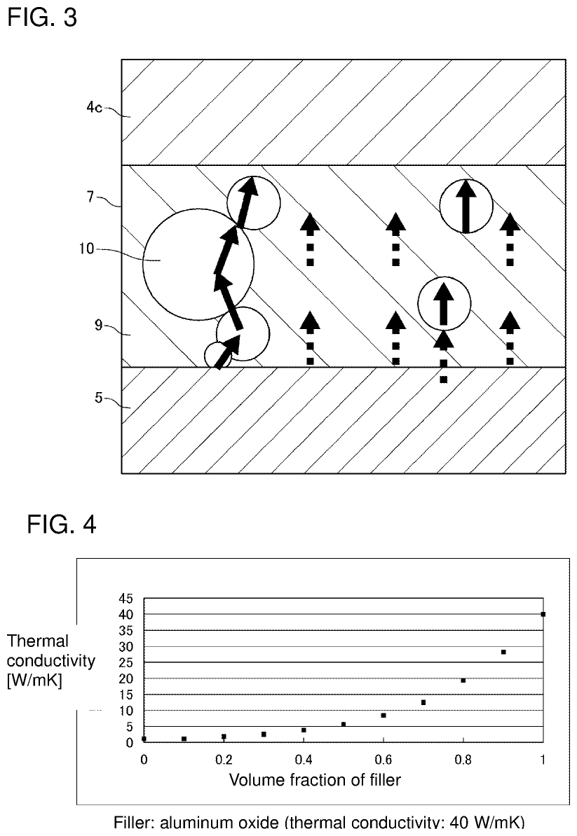

The insulating protective layer 7 is provided to protect and insulate the heating element 5 and to efficiently transmit the heat of the heating element 5 to the heating-element extraction electrode 4c and the fusible conductor 3. As shown in FIG. 3, the insulating protective layer is composed of an insulating material 9 such as glass that has thermal resistance that is inclusive of the temperature to which the heating element 5 generates heat, and a thermally conductive filler 10 is contained in this insulating material 9. A silica-based glass paste for coating over a component or a silica-based glass paste for insulation can be mentioned as examples of the raw material of the glass constituting the insulating material 9.

The insulating protective layer 7 can be formed by, for example, coating the glass-based paste by screen printing or the like and firing the glass-based paste. In the protective element 1 shown in FIG. 1, the insulating protective layer 7 is formed so as to cover the heating element 5 that is formed on the front surface 2a of the insulating substrate 2.

The thickness of the insulating protective layer 7 is set on the basis of the coatability of the glass paste or the like and the cutoff time of the fusible conductor 3. That is, the viscosity of the glass paste changes according to the content of the thermally conductive filler 10. Moreover, the coating thickness of the glass paste determines whether pin holes or the like arise that cause insulation breakdown and determines whether the paste becomes difficult to peel from the mask and produces defects in a fine opening pattern. The thermal conductivity of the insulating protective layer 7 determines whether the cutoff time of the fusible conductor 3 is extended, because increasing the thickness of the insulating protective layer 7 extends the distance to the heating-element extraction electrode 4c and the fusible conductor 3. Thus, the thickness of the insulating protective layer 7 is set as appropriate according to the coatability of the material such as the glass paste and the cutoff time of the fusible conductor 3 that is sought, this thickness being, for example, greater than 10 μm but 40 μm or less—preferably 20 to 40 μm.

### [Thermally Conductive Filler]

The thermally conductive filler 10 that is contained in the insulating material 9 has a higher thermal conductivity than the insulating material 9 constituting the insulating protective layer 7. Thus, the thermally conductive filler 10 being contained improves the thermal conduction efficiency of the insulating protective layer 7 and efficiently transmits the heat generated by the heating element 5 to the fusible conductor 3 (see FIG. 3). Accordingly, the insulating protective layer 7 can be formed to be thick enough to be able to prevent the generation of pin holes and the like so insulation breakdown is suppressed. Moreover, the heat generated by the heating element 5 can be efficiently transferred to the fusible conductor 3, and fusion can be performed rapidly. Rapidly fusing the fusible conductor 3 can also prevent the heating element 5 from becoming damaged prior to the fusion of the fusible conductor 3.

The thermally conductive filler 10 is not limited in particular as long as the filler has excellent thermal conductivity. For example, aluminum oxide, magnesium oxide, alumina, magnesia, silicon dioxide, or another metal oxide or aluminum nitride, boron nitride, or another nitride can be used as the thermally conductive filler 10. Aluminum oxide and aluminum nitride are particularly preferable in terms of thermal resistance (high thermal reliability), low specific gravity, cost savings, and the like. A thermally conductive filler that has been treated by a silane coupling agent may be used as the thermally conductive filler 10 for purposes of interface strengthening and dispersion improvement. A single type of thermally conductive filler 10 may be used, or the volumetric capacitance of the thermally conductive filler 10 that is necessary for the insulating protective layer 7 to be provided with the desired thermal transfer efficiency may be adjusted by combining two or more types of thermally conductive fillers-for example, by further containing a filler with high thermal conductivity.

The shape of the thermally conductive filler 10 is not limited in particular. For example, spherical, powdered, granular, flat, and flaky thermally conductive fillers can be mentioned.

The higher the thermal conductivity used, the more the thermally conductive filler 10 is able to improve thermal conductivity of the insulating protective layer 7, even at a small content. Moreover, the higher the thermal conductivity used, the smaller the content of the thermally conductive filler 10 needed to secure a desired thermal conductivity in the insulating protective layer 7, suppressing increase of the coating viscosity of the insulating material 9 constituting the insulating protective layer 7 and having a favorable coatability.

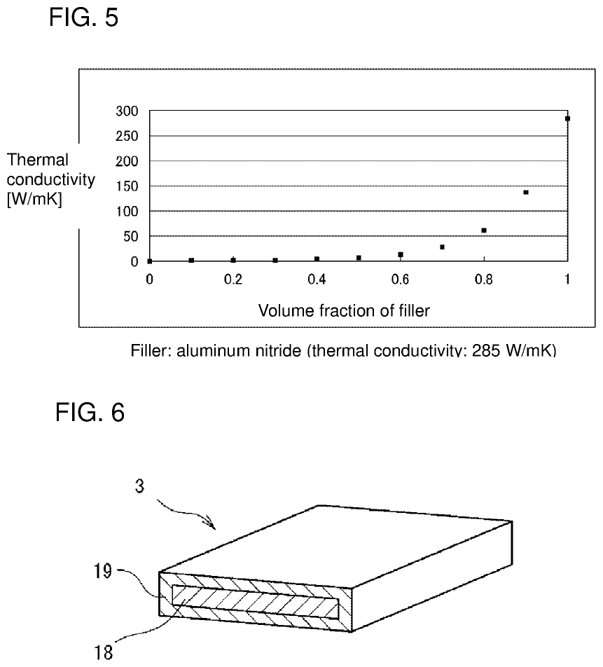

FIG. 4 is a graph showing the correspondence between thermal conductivity and the volume fraction of aluminum oxide in an insulating protective layer 7 in which aluminum oxide (thermal conductivity: 40 W/mK) is dispersed in glass (thermal conductivity: 1 W/mK). FIG. 5 is a graph showing the correspondence between thermal conductivity and the volume fraction of aluminum nitride in an insulating protective layer 7 in which aluminum nitride (thermal conductivity: 285 W/mK) is dispersed in glass (thermal conductivity: 1 W/mK).

Note that the thermal conductivity of the insulating protective layer 7 may be found by, for example, the Bruggeman formula relating to thermal conductivity of complexes of mixed fillers. In the Bruggeman formula shown below, the thermal conductivity of the resin and filler, the fill rate of the filler in the complex resin, the effects of the filler shape (spherical) and size, and the influence of the temperature distribution between the adjacent filler are considered.

$${\begin{matrix}1 - ϕ = \frac{{λ}_{c} - {λ}_{f}}{{λ}_{M} - {λ}_{f}} & ( \frac{{λ}_{M}}{{λ}_{c}}\end{matrix} )}^{1 / 3} \qquad [ Math 1 ]$$

ϕ: volume fraction of filler λ_{c}: thermal conductivity of resin

λ_{f}: thermal conductivity of filler λ_{M}: thermal conductivity of resin-filler complex

The difference between thermal conductivity of the thermally conductive filler 10 and the insulating material 9 constituting the insulating protective layer 7 is preferably made to be 19 W/mK or more. For example, when using glass (thermal conductivity: 1 W/mK) as the insulating material 9 and alumina (content 96%) (thermal conductivity: 20 W/mK) as the thermally conductive filler 10, the difference in thermal conductivity is 19 W/mK. Moreover, when using glass (thermal conductivity: 1 W/mK) as the insulating material 9 and magnesium oxide (thermal conductivity: 50 W/mK) as the thermally conductive filler 10, the difference in thermal conductivity is 49 W/mK. As described later, by using the thermally conductive filler 10 having high thermal conductivity, the volumetric capacitance of the thermally conductive filler 10 necessary for making the insulating protective layer 7 have a desired thermal conductivity decreases, a favorable coatability is had, and manufacturing efficiency can be improved.

The content of the thermally conductive filler 10 in the insulating protective layer 7 is set taking into account the thermal conductivity of the thermally conductive filler 10, the desired thermal conductivity of the insulating protective layer 7, and the coatability of the insulating material 9. The content of the thermally conductive filler 10 in the insulating protective layer 7 is preferably, for example, more than 20 vol % and less than 60 vol %. When the content of the thermally conductive filler 10 is less than 20 vol %, improvement of the thermal conductivity of the insulating protective layer 7 is not achieved and quick welding of the fusible conductor 3 would be difficult due to the thickness of the insulating protective layer 7 and the fusible conductor 3. Moreover, when the content of the thermally conductive filler 10 exceeds 60 vol %, the coating viscosity of the insulating material 9 increases and coatability would be hindered due to the coat thickness. For example, the content of the thermally conductive filler 10 for securing a 2 W/mK thermal conductivity in the insulating protective layer 7 is 20 to 25 vol % using the thermally conductive filler 10 having a high thermal conductivity of 20 W/mK or more.

The average particle size of the thermally conductive filler 10 may be, for example, in a range of 0.5 to 20 μm. Moreover, from the perspective of aiming to increase filling (densest filling) of the filling amount of the thermally conductive filler 10 and further increasing the thermal conductivity of the insulating protective layer 7, two or more types of the thermally conductive filler 10 having different average particle sizes may be used. When a single thermally conductive filler 10 is used, gaps may form between particles, but using two or more types of the thermally conductive filler 10 having different average particle sizes facilitates filling gaps between particles, and as a result, thermal conductivity of the insulating protective layer 7 can be further increased. For example, from the perspective of dispersability and high thermal conductivity, it is preferable to use a filler having a small average particle size of 0.5 to 5 μm and a filler having a large average particle size of 5 to 20 μm in combination as the thermally conductive filler 10.

Moreover, when using two or more types of the thermally conductive filler 10 having different average particle sizes in combination, the volume ratio of the thermally conductive filler 10 having a relatively small particle size and the thermally conductive filler 10 having a relatively large particle size (thermally conductive filler of small size: thermally conductive filler of large size) may be, for example, in a range of 15:85 to 90:10 or in a range of 40:60 to 60:40.

In the protective element 1, the heating element 5 and the current control element and the like formed on the external circuit are connected via the third external-connection electrode 13 by being mounted on the external circuit substrate. In the heating element 5, energization and heat generation are normally regulated, but the heating element is energized and generates heat via the third external-connection electrode 13 at a predetermined timing cutting off the energization path of the external circuit.

The protective element 1 can melt the fusible conductor 3 connecting the first and second energization units 4a, 4b by heat of the heating element 5 transmitting to the fusible conductor 3 via the insulating protective layer 7 and the heating-element extraction electrode 4c. At this time, according to the protective element 1, heat generated by the heating element 5 is efficiently conveyed to the fusible conductor 3 because the thermally conductive filler 10 is contained in the insulating material 9 constituting the insulating protective layer 7. Thus, the fusible conductor 3 can be quickly fused. Because a high thermal conductivity efficiency is provided, there is no need to form the insulating protective layer 7 to be very thin to quickly convey heat to the fusible conductor 3, so generation of pinholes and the like can be prevented and insulation breakdown can be suppressed. Moreover, by quickly fusing the fusible conductor 3, damage of the heating element 5 ahead of the fusing of the fusible conductor 3 can be prevented.

The melting conductor 3a of the fusible conductor 3 agglomerates on the heating-element extraction electrode 4c and the first and second energization units 4a, 4b, and thus the current path between the first and second energization units 4a, 4b is cut off (FIG. 2). Note that, as described later, in the heating element 5, heat generation is stopped because its own energization path is cut off by the fusible conductor 3 fusing.

### [Heating-Element Extraction Electrode]

The heating-element extraction electrode 4c formed on the insulating protective layer 7 has one end connected to the intermediate electrode 8 and overlaps the heating element 5 via the insulating protective layer 7. Moreover, in the heating-element extraction electrode 4c, the fusible conductor 3 is connected between the first and second electrodes 4a, 4b via a joining material such as connection solder.

Moreover, similarly to the first and second electrodes 4a, 4b, the heating-element extraction electrode 4c may be formed by printing and firing a conduction paste of Ag, Cu, or the like. Moreover, it is preferable that a film of Ni/Au plating, Ni/Pd plating, Ni/Pd/Au plating, or the like is coated on the front surface of the heating-element extraction electrode 4c by known plating means such as a plating process.

### [Fusible Conductor]

Next, the fusible conductor 3 is described. The fusible conductor 3 is mounted between the first and second electrodes 4a, 4b, is fused by heat generation by energization of the heating element 5 or by its own heat generation (Joule heat) due to energization of a current exceeding the rated value, and the current path between the first electrode 4a and the second electrode 4b is cut off.

The fusible conductor 3 may be of a conductive material that melts due to heat generation from energization of the heating element 5 or from an overcurrent state and may use, for example, a SnAgCu-based lead-free solder, a BiPbSn alloy, a BiPb alloy, a BiSn alloy, a SnPb alloy, a PbIn alloy, a ZnAl alloy, an InSn alloy, a PbAgSn alloy, or the like.

Moreover, the fusible conductor 3 may be a structure containing a high-melting-point metal and a low-melting-point metal. For example, as illustrated in FIG. 6, the fusible conductor 3 is a laminated structure composed of an inner layer and an outer layer and has a low-melting-point metal layer 18 as the inner layer and a high-melting-point metal layer 19 as the outer layer laminated on the low melting point layer 18. The fusible conductor 3 is connected on the first and second electrodes 4a, 4b and the heating-element extraction electrode 4c via a joining material such as connection solder.

The low-melting-point metal layer 18 is preferably a metal having solder or Sn as a main component and is preferably a material generally known as “lead-free solder”. The melting point of the low-melting-point metal layer 18 does not necessarily need to be higher than the reflow temperature, and may be melted at approximately 200° C. The high-melting-point metal layer 19 is a metal layer laminated on the front surface of the low-melting-point metal layer 18 and is, for example, Ag, Cu, or a metal having one of these as a main component, and has a high melting point in which it does not melt even when connection of the first and second electrodes 4a, 4b and the heating-element extraction electrode 4c to the fusible conductor 3, or mounting onto the external circuit board of the protective element 1 are performed by reflow.

Such a fusible conductor 3 may be formed by forming the high-melting-point metal layer into a film on a low-melting-point metal foil using a plating art, or may be formed using another known laminating art or film forming art. Moreover, the fusible conductor 3 may have a structure wherein the entire surface of the low-melting-point metal layer 18 is covered by the high-melting-point metal layer 19 or may be a structure which is covered except for a pair of mutually opposing side surfaces. Note that the fusible conductor 3 may be configured having the high-melting-point metal layer 19 as the inner layer and the low-melting-point metal layer 18 as the outer layer and may be formed by various configurations such as having a multi-layer structure in which the low-melting-point metal layer 18 and the high-melting-point metal layer 19 are alternatingly laminated in three or more layers and an aperture is provided in a portion of the outer layer, exposing a portion of the inner layer.

By laminating the high-melting-point metal layer 19 as the outer layer on the low-melting-point metal layer 18 which makes up the inner layer, the fusible conductor 3 can maintain a shape as the fusible conductor 3 and does not become fused even if the reflow temperature exceeds the melting temperature of the low-melting-point metal layer 18. Therefore, connection of the first and second electrodes 4a, 4b and the heating-element extraction electrode 4c to the fusible conductor 3, or mounting onto the external circuit board of the protective element 1 can be efficiently performed by reflow. Also, using reflow, fluctuation of fusing properties such as not fusing at a predetermined temperature due to localized increase or decrease and the like of resistance values accompanying deformation of the fusible conductor 3, or fusing below a predetermined temperature can be prevented.

Moreover, the fusible conductor 3 also does not fuse due to its own heat generation while a predetermined rated current is flowing. Furthermore, when a current value higher than the rated value flows, the conductor melts due to its own heat generation, cutting off the current path between the first and second electrodes 4a, 4b. Moreover, the conductor melts by the heating element 5 being energized and generating heat and cutting off the current path between the first and second electrodes 4a, 4b.

At this time, in the fusible conductor 3, the high-melting-point metal layer 19 is liquified at a temperature lower than the melting temperature due to the melted low-melting-point metal layer 18 corroding the high-melting-point metal layer 19 (solder corrosion). Therefore, the fusible conductor 3 can fuse in a short time using a corrosion action of the high-melting-point metal layer 19 due to the low-melting-point metal layer 18. Moreover, because the melting conductor 3a of the fusible conductor 3 is divided by a physical drawing-in action of the heating-element extraction electrode 4c and the first and second electrodes 4a, 4b, the current path between the first and second electrodes 4a, 4b can be quickly and reliably cut off (FIG. 2).

Moreover, in the fusible conductor 3, it is preferable that the volume of the low-melting-point metal layer 18 is formed at a higher volume than the high-melting-point metal layer 19. The fusible conductor 3 is heated by its own heat generation due to an overcurrent or by heat generation of the heating element 5 and corrodes the high-melting-point metal due to the low-melting-point metal melting, and is thereby capable of quick melting and fusing. Thus, the fusible conductor 3 promotes this corrosion action by forming the volume of the low-melting-point metal layer 18 at a higher volume than the high-melting-point metal layer 19, and can quickly cut off the first and second electrodes 4a, 4b.

Moreover, due to being configured having the high-melting-point metal layer 19 laminated on the low-melting-point metal layer 18 which makes up the inner layer, the fusible conductor 3 can reduce a fusing temperature much further than a conventional chip fuse or the like composed of a high-melting-point metal. Thus, the fusible conductor 3 can increase a cross-sectional area compared to a chip fuse or the like of the same size and can greatly improve a rated current value. Moreover, the conductor can achieve a smaller and thinner size than a conventional fuse chip having the same rated current value, and has excellent quick fusing properties.

Moreover, the fusible conductor 3 can improve resistance to a surge in which an abnormally high voltage is instantaneously applied to the electrical system in which the protective element 1 is incorporated (pulse resistance). That is, the fusible conductor 3 does not fuse until, for example, a 100 A current flows for several milliseconds. With respect to this point, because a large current flowing for an extremely short time flows through a surface layer of the conductor (skin effect), the fusible conductor 3 is provided with a high-melting-point metal layer 19 such as an Ag plate having a low resistance value as the outer layer, and thus flowing of a current applied by a surge is facilitated and fusing due to its own heat generation can be prevented. Thus, the fusible conductor 3 can greatly improve resistance to surges compared to fuses composed of a conventional solder alloy.

Note the fusible conductor 3 may be coated with flux (not illustrated) for oxidation prevention, improvement of wettability during fusing, and the like. Moreover, in the protective element 1, the interior of the insulating substrate 2 is protected by being covered by a case 17. The case 17 may be formed by, for example, using a member having insulating properties such as various engineering plastics, a thermoplastic, a ceramic, a glass epoxy substrate, or the like. Moreover, the case 17 is provided with an interior space on the front surface 2a of the insulating substrate 2 that is sufficient for the fusible conductor 3 to expand to a sphere during melting and the melting conductor 3a to agglomerate on the heating-element extraction electrode 4c and the first and second electrode 4a, 4b.

### Circuit Configuration Example

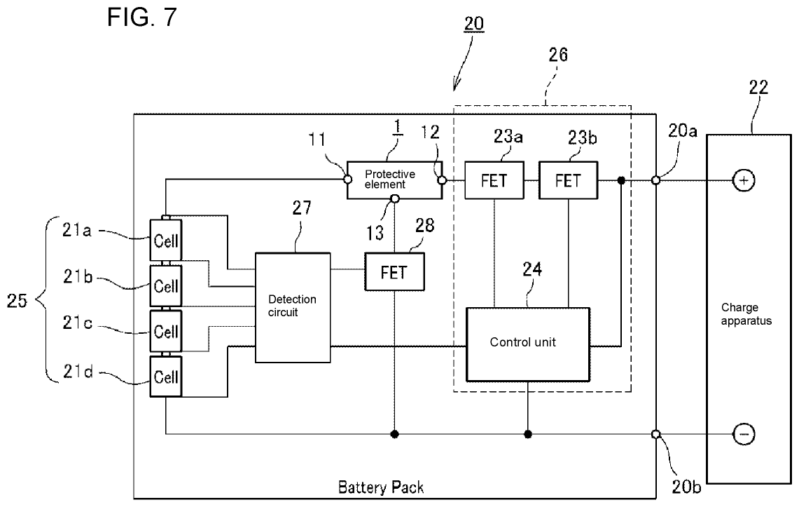

Such a protective element 1 is used, for example, by being incorporated in a circuit inside a battery pack 20 of a lithium ion secondary battery. As illustrated in FIG. 7, the battery pack 20 has, for example, a battery stack 25 composed of a total of four lithium ion secondary battery cells 21a to 21d.

The battery pack 20 is provided with a battery stack 25, a charge/discharge control circuit 26 for controlling charge and discharge of the battery stack 25, the protective element 1 to which the present invention is applied and for cutting off a charge/discharge path during an abnormality of the battery stack 25, a detection circuit 27 for detecting a voltage of each of the battery cells 21a to 21d, and a current control element 28 which makes up a switch element for controlling operation of the protective element 1 in response to detection results of the detection circuit 27.

The battery stack 25 has the battery cells 21a to 21d—requiring control for protection from overcharge and overdischarge states-connected in series, and, via a positive terminal 20a and a negative terminal 20b of the battery pack 20, is detachably connected to a charge apparatus 22, and has a charge voltage applied from the charge apparatus 22. By the positive terminal 20a and the negative terminal 20b being connected to an electronic device that operates by a battery, the battery pack 20 charged by the charge apparatus 22 is able to operate this electronic device.

The charge/discharge control circuit 26 is provided with two current control elements 23a, 23b connected in series to the current path between the battery stack 25 and the charge apparatus 22, and a control unit 24 for controlling operation of these current control elements 23a, 23b. The current control elements 23a, 23b are configured by, for example, a field effect transistor (hereinafter referred to as FET) and control conduction and cutting off in the charge direction and/or discharge direction of the current path of the battery stack 25 by controlling a gate voltage using the control unit 24. The control unit 24 operates by receiving power supply from the charge apparatus 22 and, when the battery stack 25 is overdischarged or overcharged, controls operation of the current control elements 23a, 23b to cut off the current path in response to detection results from the detection circuit 27.

The protective element 1 is, for example, connected on the charge/discharge current path between the battery stack 25 and the charge/discharge control circuit 26, and operation thereof is controlled by the current control element 28.

The detection circuit 27 is connected to each of the battery cells 21a to 21d, detects a voltage value of each of the battery cells 21a to 21d, and supplies each voltage value to the control unit 24 of the charge/discharge control circuit 26. Moreover, the detection circuit 27 outputs a control signal for controlling the current control element 28 when any one of the battery cells 21a to 21d has reached an overcharge voltage or an overdischarge voltage.

The current control element 28 is configured by, for example, an FET, and operates the protective element 1 using a detection signal output from the detection circuit 27 when a voltage value of the battery cells 21a to 21d reaches a voltage exceeding a predetermined overdischarge or overcharge state, and performs control to cut off the charge/discharge current path of the battery stack 25 without depending on switch operation of the current control element 23a, 23b.

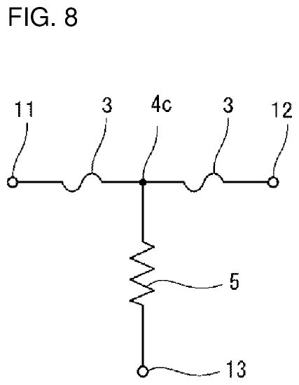

The protective element 1 used in the battery pack 20 composed of a configuration as described above and to which the present invention is applied has a circuit configuration as illustrated in FIG. 8. That is, in the protective element 1, the first external-connection electrode 11 is connected on the battery stack 25 side and the second external-connection electrode 12 is connected on the positive terminal 20a side, and thus, the fusible conductor 3 is connected in series on the charge/discharge path of the battery stack 25. Moreover, in the protective element 1, the heating element 5 is connected to the current control element 28 via the heating-element electrode 6 and the third external-connection electrode 13, and the heating element 5 is connected to an open end of the battery stack 25. Thus, in the heating element 5, one end is connected to the fusible conductor 3 and one open end of the battery stack 25 via the heating-element extraction electrode 4c, and another end is connected to the current control element 28 and another open end of the battery stack 25 via the third external-connection electrode 13. This forms a supply path to the heating element 5 in which energization is controllable by the current control element 28.

### [Operation of Protective Element]

When the detection circuit 27 detects an abnormal voltage of any of the battery cells 21a to 21d, it outputs a cutoff signal to the current control element 28. Then the current control element 28 controls the current so that it is energized to the heating element 5. In the protective element 1, a current flows from the battery stack 25 to the heating element 5. Thus the heating element 5 starts heat generation. In the protective element 1, the fusible conductor 3 fuses due to heat generation of the heating element 5 and cuts off the charge/discharge path of the battery stack 25. Moreover, due to the fusible conductor 3 being formed containing a high-melting-point metal and a low-melting-point metal, the low-melting-point metal melts before fusing of the high-melting-point metal, and the protective element 1 can liquify the fusible conductor 3 in a short time using a corrosion action of the high-melting-point metal due to the melted low-melting-point metal.

At this time, thermal conductivity of the protective element 1 is improved by the thermally conductive filler 10 being contained in the insulating protective layer 7. Thus, the insulating protective layer 7 can efficiently transmit heat generation of the heating element 5 to the fusible conductor 3 and quickly fuse such. Moreover, the insulating protective layer 7 need not be formed to be extremely thin and can prevent generation of pinholes and the like, and therefore, can prevent insulation breakdown (sparks) between the heating-element electrode 6, the first extraction electrode 15 or the heating element 5, and the heating-element extraction electrode 4c. Furthermore, by quickly fusing the fusible conductor 3, damage of the heating element 5 ahead of fusing of the fusible conductor 3 can be prevented and the current path can safely and quickly be cut off.

In the protective element 1, heat generation of the heating element 5 is stopped because the supply path to the heating element 5 is also cut off by the fusible conductor 3 being fused.

Note that in the protective element 1, when an overcurrent exceeding the rated value is energized to the battery pack 20, the fusible conductor 3 is melted by its own heat generation and the charge/discharge path of the battery pack 20 can be cut off.

In this manner, in the protective element 1, the fusible conductor 3 is fused by heat generation from energization of the heating element 5 or by heat generation of the fusible conductor 3 itself by an overcurrent. As described above, in the protective element 1, during reflow mounting to a circuit board or when a circuit board on which the protective element 1 is mounted is further exposed under a high temperature environment such as reflow heating, deformation of the fusible conductor 3 is controlled by having a structure in which the low-melting-point metal layer is covered by the high-melting-point metal layer. Therefore, fluctuations in fusing properties caused by fluctuations in resistance value due to deformation of the fusible conductor 3 or the like are prevented and fusing can be quickly performed by heat generation of a predetermined overcurrent or heat generation of the heating element 5.

The protective element 1 according to the present invention is not limited to cases of being used in a battery pack of lithium ion secondary cells, and application to various uses which require cutting off the current path by an electric signal is, of course, possible.

### Modified Example 1

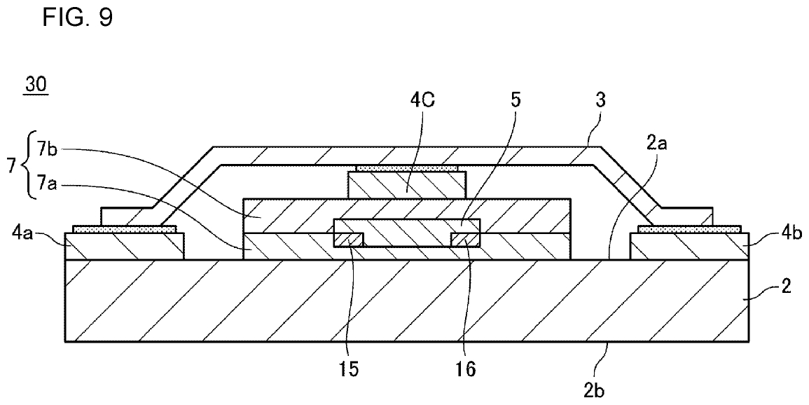

A modified example of the protective element to which the present art is applied will be described. Note that in the below description, members that are the same as the protective element 1 described above are given the same reference signs and details thereof may be omitted. In a protective element 30 illustrated in FIG. 9, the insulating protective layer 7 is configured by a substrate-side protective layer 7a wherein the heating element 5 is formed on the front surface and a covering protective layer 7b that covers the heating element 5 formed on the substrate-side protective layer 7a. The substrate-side protective layer 7a is formed on the front surface 2a of the insulating substrate 2, and the heating element 5 and the first and second extraction electrodes 15, 16 are formed. The covering protective layer 7b covers the substrate-side protective layer 7a and the heating element 5 by being laminated and formed on the substrate-side protective layer 7a. Thus, the heating element 5 is provided in an interior of the insulating protective layer 7. Moreover, the heating-element extraction electrode 4c is laminated on the covering protective layer 7b. The method of forming the substrate-side protective layer 7a and the covering protective layer 7b is the same as the insulating protective layer 7 described above.

The covering protective layer 7b preferably has a higher thermal conductivity than the substrate-side protective layer 7a. Thus, it becomes possible to impede heat generation of the heating element 5 escaping to the insulating substrate 2 side and to quickly transmit heat from the covering protective layer 7b side, and the amount of heat conveyed to the covering protective layer 7b side per unit of time increases, and the fusible conductor 3 can be efficiently heated. As a method for increasing thermal conductivity of the covering protective layer 7b to higher than the substrate-side protective layer 7a, there is, for example, a method of containing the thermally conductive filler 10 in only the covering protective layer 7b and not containing the thermally conductive filler 10 in the substrate-side protective layer 7a. There is also a method of using a thermally conductive filler that has higher thermal conductivity than the thermally conductive filler 10 contained in the substrate-side protective layer 7a as the thermally conductive filler 10 contained in the covering protective layer 7b. Alternatively, there is a method of making the amount of the thermally conductive filler 10 contained in the covering protective layer 7b greater than the amount of the thermally conductive filler 10 contained in the substrate-side protective layer 7a. The present art is, of course, not limited to these methods as methods for increasing the thermal conductivity of the covering protective layer 7b to higher than the substrate-side protective layer 7a.

### Modified Example 2

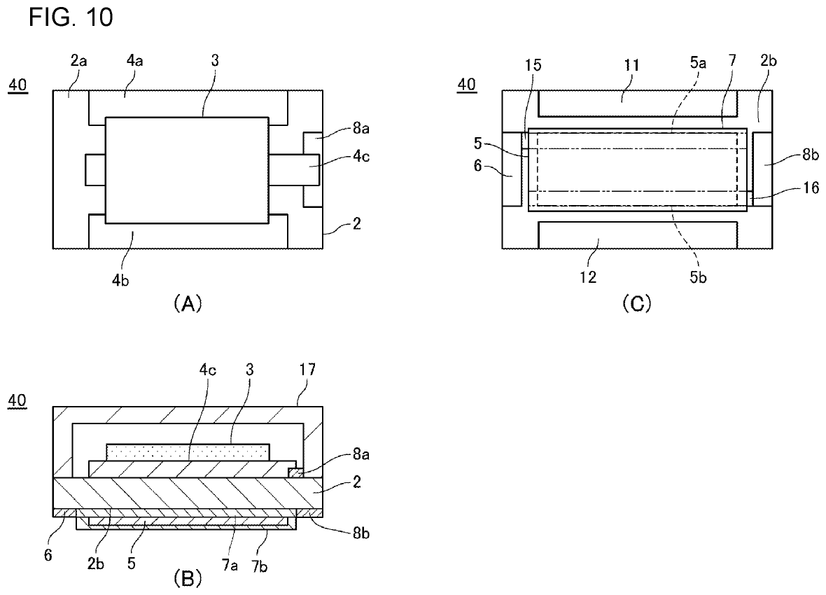

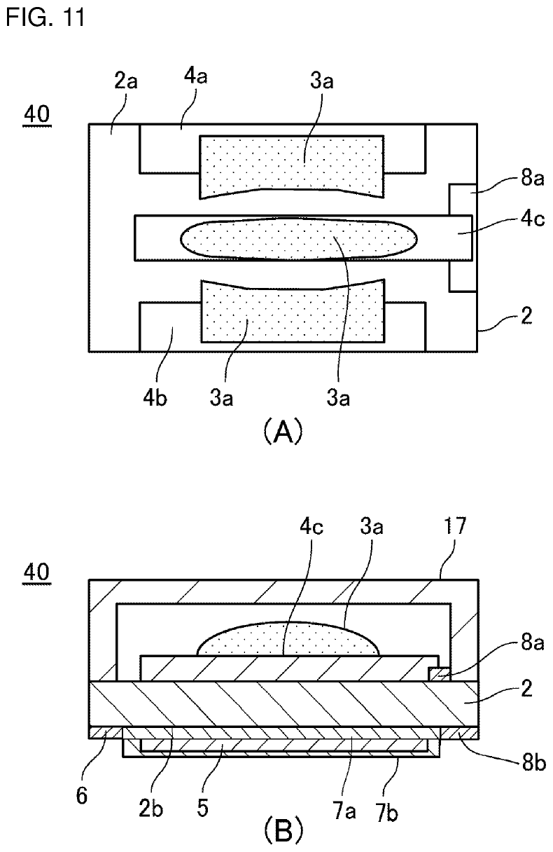

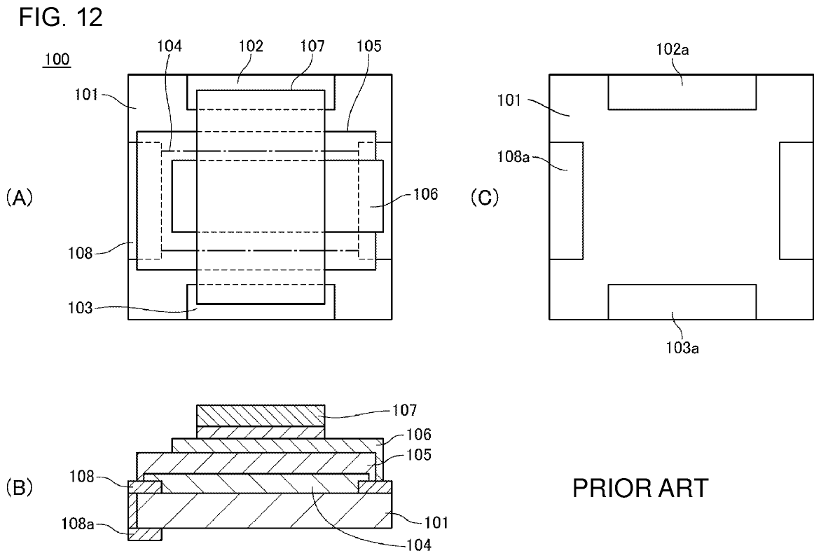

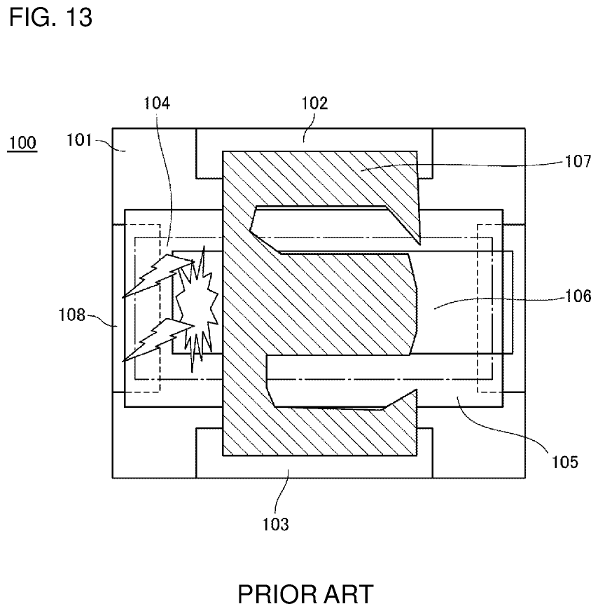

Next, another modified example of the protective element to which the present art is applied will be described. Note that in the below description, members that are the same as the protective elements 1, 30 described above are given the same reference signs and details thereof may be omitted. As illustrated in FIG. 10 and FIG. 11, a protective element 40 to which the present art is applied may be provided with a heating element on a rear surface of the insulating substrate. In the protective element 40, the heating element 5, the first and second extraction electrodes 15, 16, and the insulating protective layer 7 covering these are formed on a rear surface 2b of the insulating substrate 2 which is on the opposite side of the front surface 2a. Moreover, the heating-element electrode 6, a rear-surface-side intermediate electrode 8b, and the first and second external-connection electrodes 11, 12 are formed on the rear surface 2b of the insulating substrate 2.

Moreover, the first and second electrodes 4a, 4b, the fusible conductor 3, the heating-element extraction electrode 4c, and a front-surface-side intermediate electrode 8a are formed on the front surface 2a of the insulating substrate 2.

In the rear-surface-side intermediate electrode 8b, similarly to the intermediate electrode 8 described above, the second extraction electrode 16 is extracted. Moreover, the front-surface-side intermediate electrode 8a and the rear-surface-side intermediate electrode 8b are electrically connected by castellations formed on a side surface of the insulating substrate 2, a conduction through-hole passing through the insulating substrate 2, and the like. The heating-element extraction electrode 4c is connected to the front-surface-side intermediate electrode 8a. The front-surface-side intermediate electrode 8a and the rear-surface-side intermediate electrode 8b may be formed by similar materials and similar procedures to the intermediate electrode 8 described above.

The heating-element extraction electrode 4c is electrically and thermally connected to the heating element 5 via the front-surface-side intermediate electrode 8a and the rear-surface-side intermediate electrode 8b. That is, in the protective element 40, the heating element 5 heats the heating-element extraction electrode 4c via the insulating substrate 2, and heat of the heating element 4 is conveyed to the heating-element extraction electrode 4c via the front-surface-side intermediate electrode 8a and rear-surface-side intermediate electrode 8b having excellent thermal conductivity, whereby the fusible conductor 3 can be heated and fused (FIG. 11 (A)(B)).

Note that in the protective element 40, the heating-element electrode 6 also becomes an external-connection electrode connected to an electrode of an external circuit board, so the third external-connection electrode 13 provided in the protective element 1 is not provided.

In the protective element 40, similarly to the protective element 30, the insulating protective layer 7 is configured by a substrate-side protective layer 7a wherein the heating element 5 is formed on the front surface and a covering protective layer 7b that covers the heating element 5 formed on the substrate-side protective layer 7a. The substrate-side protective layer 7a is formed on the rear surface 2b of the insulating substrate 2, and the heating element 5 and the first and second extraction electrodes 15, 16 are formed on the front surface. The covering protective layer 7b covers the substrate-side protective layer 7a and the heating element 5 by being laminated and formed on the substrate-side protective layer 7a.

The covering protective layer 7b according to the protective element 40 preferably has a lower thermal conductivity than the substrate-side protective layer 7a. Thus, it becomes possible to impede heat generation of the heating element 5 escaping to the covering protective layer 7b side and to quickly transmit heat from the insulating substrate 2 side, and the amount of heat conveyed to the substrate-side protective layer 7a side per unit of time increases, and the fusible conductor 3 can be efficiently heated. As a method for increasing thermal conductivity of the substrate-side protective layer 7a to higher than the covering protective layer 7b, there is, for example, a method of containing the thermally conductive filler 10 in only the substrate-side protective layer 7a and not containing the thermally conductive filler 10 in the covering protective layer 7b. There is also a method of using a thermally conductive filler that has higher thermal conductivity than the thermally conductive filler 10 contained in the covering protective layer 7b as the thermally conductive filler 10 contained in the substrate-side protective layer 7a. Alternatively, there is a method of making the amount of the thermally conductive filler 10 contained in the substrate-side protective layer 7a greater than the amount of the thermally conductive filler 10 contained in the covering protective layer 7b. The present art is, of course, not limited to these methods as methods for increasing the thermal conductivity of the substrate-side protective layer 7a to higher than the covering protective layer 7b.

### Example 1

Next, Example 1 and Eexample 2 of the present art will be described. In Example 1, a glass layer was formed as the insulating protective layer, a protective element sample in which the thickness and thermal conductivity of the glass layer were changed was prepared, and a time needed from energization of the heating element until cutting off the fusible conductor (cutting off time) was measured. The configuration of the protective element was the same as the protective element 30 described above. The heating element was formed by ruthenium oxide and the thickness was set to 15 μm. A 15 A current was energized to the heating element at an applied voltage of 60 V.

The film thickness of the glass layer refers to the film thickness of the covering protective layer of the heating element upper part, and the film thickness of each sample was set to 10 μm, 20 μm, 30 μm, and 40 μm. The thickness of the substrate-side protective layer was set to 15 μm. Aluminum oxide (thermal conductivity: 40 W/mK) was used for the thermally conductive filler contained in the glass layer. Moreover, the thermal conductivity of the glass layer was adjusted in a range of 1 W/mK to 20 W/mK by changing the volume fraction of the thermally conductive filler (see FIG. 4).

Evaluation of the protective element samples used cutting off time as a standard, with 0.2 seconds or less being excellent (⊚), more than 0.2 seconds and 0.3 seconds or less being good (○), and more than 0.3 seconds being poor (x). When insulation breakdown occurred when a voltage was applied, all protective element samples having the corresponding film thickness were evaluated as being poor (x), regardless of the thermal conductivity of the glass layer.

TABLE 1

| Glass layer | Short circuit | | Thermal conductivity of insulating protective layer [W/mK] | | | | | | | | | | | | |
|---|---|---|---|---|---|---|---|---|---|---|---|---|---|---|---|
| thickness [μm] | occurrence? | | 1 | 1.25 | 1.5 | 1.75 | 2 | 2.25 | 2.5 | 2.75 | 3 | 5 | 10 | 15 | 20 |
| 10 | Yes | Fusing | — | — | — | — | — | — | — | — | — | — | — | — | — |
| | | time [sec] | | | | | | | | | | | | | |

| | | | | | | | | | | | | | |
|---|---|---|---|---|---|---|---|---|---|---|---|---|---|
| Evaluation | X | X | X | X | X | X | X | X | X | X | X | X | X |

TABLE 2

| Glass layer | Short circuit | | Thermal conductivity of insulating protective layer [W/mK] | | | | | | | | | | | | |
|---|---|---|---|---|---|---|---|---|---|---|---|---|---|---|---|
| thickness [μm] | occurrence? | | 1 | 1.25 | 1.5 | 1.75 | 2 | 2.25 | 2.5 | 2.75 | 3 | 5 | 10 | 15 | 20 |
| 20 | No | Fusing | 0.300 | 0.240 | 0.200 | 0.171 | 0.150 | 0.133 | 0.120 | 0.109 | 0.100 | 0.060 | 0.030 | 0.020 | 0.015 |
| | | time [sec] | | | | | | | | | | | | | |

| | | | | | | | | | | | | | |
|---|---|---|---|---|---|---|---|---|---|---|---|---|---|
| Evaluation | ◯ | ◯ | ⊚ | ⊚ | ⊚ | ⊚ | ⊚ | ⊚ | ⊚ | ⊚ | ⊚ | ⊚ | ⊚ |

TABLE 3

| Glass layer | Short circuit | | Thermal conductivity of insulating protective layer [W/mK] | | | | | | | | | | | | |
|---|---|---|---|---|---|---|---|---|---|---|---|---|---|---|---|
| thickness [μm] | occurrence? | | 1 | 1.25 | 1.5 | 1.75 | 2 | 2.25 | 2.5 | 2.75 | 3 | 5 | 10 | 15 | 20 |
| 30 | No | Fusing | 0.450 | 0.360 | 0.360 | 0.257 | 0.225 | 0.200 | 0.180 | 0.164 | 0.150 | 0.090 | 0.045 | 0.030 | 0.023 |
| | | time [sec] | | | | | | | | | | | | | |

| | | | | | | | | | | | | | |
|---|---|---|---|---|---|---|---|---|---|---|---|---|---|
| Evaluation | X | X | ◯ | ◯ | ◯ | ⊚ | ⊚ | ⊚ | ⊚ | ⊚ | ⊚ | ⊚ | ⊚ |

TABLE 4

| Glass layer | Short circuit | | Thermal conductivity of insulating protective layer [W/mK] | | | | | | | | | | | | |
|---|---|---|---|---|---|---|---|---|---|---|---|---|---|---|---|
| thickness [μm] | occurrence? | | 1 | 1.25 | 1.5 | 1.75 | 2 | 2.25 | 2.5 | 2.75 | 3 | 5 | 10 | 15 | 20 |
| 40 | No | Fusing | 0.600 | 0.480 | 0.400 | 0.343 | 0.300 | 0.267 | 0.240 | 0.218 | 0.200 | 0.120 | 0.060 | 0.040 | 0.030 |
| | | time [sec] | | | | | | | | | | | | | |

| | | | | | | | | | | | | | |
|---|---|---|---|---|---|---|---|---|---|---|---|---|---|
| Evaluation | X | X | X | X | ◯ | ◯ | ◯ | ◯ | ⊚ | ⊚ | ⊚ | ⊚ | ⊚ |

As shown in Table 1, insulation breakdown occurred in protective element samples in which film thickness of the glass layer was set to 10 μm, and therefore all samples of the corresponding film thickness were evaluated as being poor.

As shown in Table 2, in protective elements having film thickness of the glass layer set to 20 μm, cutting off time was 0.3 seconds or less for all samples.

As shown in Table 3, for protective elements having film thickness of the glass layer set to 30 μm, in samples having thermal conductivity of the glass layer of 1 W/mK and 1.25 W/mK, cutting off time was more than 0.3 seconds, but in samples having thermal conductivity of the glass layer of 1.5 W/mK or more, cutting off time was 0.3 seconds or less.

As shown in Table 4, for protective elements having film thickness of the glass layer set to 40 μm, in samples having thermal conductivity of the glass layer of 1 W/mK to 1.75 W/mK, cutting off time was more than 0.3 seconds, but in samples having thermal conductivity of the glass layer of 2 W/mK or more, cutting off time was 0.3 seconds or less.

As described above, the higher the thermal conductivity of the insulating protective layer is made by being made to contain a thermally conductive filler of high thermal conductivity, the thicker the insulating protective layer can be formed, and a highly reliable protective element in which insulation breakdown is prevented can be provided, and fusing time can be shortened. Moreover, when the thickness of the insulating protective layer is the same, the higher the thermal conductivity of the insulating protective layer, the more the fusing time can be shortened, and a more responsive a protective element can be provided.

### Example 2

In Example 2, a glass layer was formed as the insulating protective layer, a volumetric capacitance (%) of the thermally conductive filler needed to make the thermal conductivity of the insulating protective layer 2 W/mK was found for each thermal conductivity of the thermally conductive filler, and coatability of the glass paste was evaluated.

In the insulating protective layer, the glass paste was formed by screen printing on the insulating substrate. An aperture of the mask was made to be 1000×100 μm and the coat thickness of the glass paste was made to be 20 μm.

The coatability evaluation indices were as follows: ◯ (excellent) when printing was completed smoothly without pinholes or defects in the coat pattern, Δ (normal) when printing speed was lowered and a favorable printing state was obtained, and x (poor) when pinholes or defects occurred even though printing speed was lowered.

TABLE 5

| | Thermal | Volumetric | |
|---|---|---|---|
| | conductivity of | capacitance | |
| | thermally | (thermal | |
| Thermally | conductive filler | conductivity | |
| conductive filler | [W/mK] | 2 W/mK) [%] | Coatability |
| Crystalline silica | 10 | 35 | Δ |
| Alumina 96% | 20 | 25 | ◯ |
| Alumina 99.7% or | 40 | 22 | ◯ |
| more | | | |
| Magnesium oxide | 50 | 21 | ◯ |
| Aluminum nitride | 285 | 20 | ◯ |

As shown in Table 5, it was found that when the volumetric capacitance of the thermally conductive filler in relation to the glass paste was 35% or more, this invited viscosity increase of the glass paste constituting the insulating protective layer, causing a decrease in coatability.

That is, the lower the thermal conductivity of the thermally conductive filler, the higher the volumetric capacitance of the thermally conductive filler needed to make the thermal conductivity of the insulating protective layer 2 W/mK, inviting viscosity increase of the glass paste constituting the insulating protective layer, and thus causing a decrease in coatability.

Meanwhile, the higher the thermal conductivity of the thermally conductive filler, the lower the volumetric capacitance of the thermally conductive filler needed to make the thermal conductivity of the insulating protective layer 2 W/mK, thus suppressing viscosity increase of the glass paste, and providing favorable coatability.

In Example 2, it was found that by suppressing the volumetric capacitance of the thermally conductive filler to at or below 25%, a glass paste having favorable coatability can be provided. Thus, it was found that to make the thermal conductivity of the insulating protective layer 2 W/mK, it is effective to include a thermally conductive filler having a thermal conductivity of at least 20 W/mK as the thermally conductive filler.

### DESCRIPTION OF REFERENCE SIGNS

1 Protective element, 2 Insulating substrate, 3 Fusible conductor, 4a First electrode, 4b Second electrode, 4c Heating-element extraction electrode, 5 Heating element, 6 Heating-element electrode, 7 Insulating protective layer, 7a Substrate-side protective layer, 7b Covering protective layer, 8 Intermediate electrode, 9 Insulating material, 10 Thermally conductive filler, 11 First external-connection electrode, 12 Second external-connection electrode, 13 Third external-connection electrode, 15 First extraction electrode, 16 Second extraction electrode, 18 Low-melting-point metal layer, 19 High-melting-point metal layer, 20 Battery pack, 21 Battery cell, 22 Charge apparatus, 23 Current control element, 24 Control unit, 25 Battery stack, 26 Charge/discharge control circuit, 27 Detection circuit, 28 Current control element, 30 Protective element, 40 Protective element

1. A protective element comprising:
an insulating substrate;
first and second electrodes provided on the insulating substrate;
a heating element formed on the insulating substrate;
a heating-element extraction electrode electrically connected to the heating element;
a fusible conductor mounted from the first electrode to the second electrode with the heating-element extraction electrode interposed between the first and second electrodes; and
an insulating protective layer which covers the heating element and comprises a thermally conductive filler.

2. The protective element of claim 1, wherein the thermally conductive filler comprises an aluminum oxide particle and/or an aluminum nitride particle.

3. The protective element of claim 1, wherein the insulating protective layer has a thickness of 20 μm or greater.

4. The protective element of claim 1, wherein the thermal conductivity of the insulating protective layer is 1.5 W/mK or higher.

5. The protective element of claim 1, wherein the insulating protective layer further comprises an insulating material, and an amount of the thermally conductive filler by volume relative to an amount of the insulating material by volume is 20% or higher.

6. The protective element claim 1, wherein the heating element and the insulating protective layer are formed on a face on which the fusible conductor is mounted of the insulating substrate.

7. The protective element of claim 1, wherein the heating element and the insulating protective layer are formed on a face that is on the opposite side of a face on which the fusible conductor is mounted of the insulating substrate.

8. A battery pack, comprising:
one or more battery cells;
a protective element connected on a charge/discharge path of the battery cell and configured to cut off the charge/discharge path; and
a current control element configured to detect a voltage value of the battery cell and to control energization of the protective element; wherein:
the protective element comprises:
an insulating substrate;
first and second electrodes provided on the insulating substrate;
a heating element formed on the insulating substrate;
a heating-element extraction electrode electrically connected to the heating element;
a fusible conductor mounted from the first electrode to the second electrode with the heating-element extraction electrode interposed between the first and second electrodes; and
an insulating protective layer which covers the heating element and comprises a thermally conductive filler.

9. The battery pack of claim 8, wherein the thermally conductive filler comprises an aluminum oxide particle and/or an aluminum nitride particle.

10. The battery pack of claim 8, wherein the insulating protective layer has a thickness of 20 μm or greater.

11. The battery pack of claim 8, wherein the thermal conductivity of the insulating protective layer is 1.5 W/mK or higher.

12. The battery pack of claim 8, wherein the insulating protective layer further comprises an insulating material, and an amount of the thermally conductive filler by volume relative to an amount of the insulating material by volume is 20% or higher.

13. The battery pack of claim 8, wherein the heating element and the insulating protective layer are formed on a face on which the fusible conductor is mounted of the insulating substrate.

14. The battery pack of claim 8, wherein the heating element and the insulating protective layer are formed on a face that is on the opposite side of a face on which the fusible conductor is mounted of the insulating substrate.
